(19) United States
(12) Patent Application Publication
(10) Pub. No.: US 2015/0091306 A1
(43) Pub. Date: Apr. 2, 2015

(54) SYSTEM AND METHOD FOR DOWNHOLE POWER GENERATION USING A DIRECT DRIVE PERMANENT MAGNET MACHINE

(71) Applicant: National Oilwell Varco, L.P., Houston, TX (US)

(72) Inventor: Micheal Albert Pridgeon, Conroe, TX (US)

(73) Assignee: National Oilwell Varco, L.P., Houston, TX (US)

(21) Appl. No.: 14/501,448

(22) Filed: Sep. 30, 2014

Related U.S. Application Data
(60) Provisional application No. 61/884,394, filed on Sep. 30, 2013.

(51) Int. Cl. E21B 41/00; F03B 13/10; H02K 7/18

(52) U.S. Cl. CPC E21B 41/0085; H02K 7/1823; F03B 13/10
USPC 290/54

(57) ABSTRACT

A system and method for generation of electrical energy by a downhole tool in a wellbore. A downhole tool for use in a wellbore includes a housing and a power generation system disposed within the housing. The power generation system includes a power section and an axial flux generator. The power section is configured to convert flow of drilling fluid through the downhole tool to rotation. The axial flux generator is coupled to the power section. The axial flux generator is configured to produce magnetic flux that extends parallel to an axis of the rotation, and to generate electrical energy responsive to the rotation.

### CROSS-REFERENCE TO RELATED APPLICATIONS

The present application claims the benefit of U.S. Provisional Application No. 61/884,394, filed Sep. 30, 2013, entitled “Downhole Tool With Direct Drive Permanent Magnet Machine,” which is incorporated herein by reference in its entirety for all purposes.

### BACKGROUND

In the drilling of oil and gas wells, various downhole tools are typically included in the drill string. The downhole tools may provide, for example, control of drilling operations, measurement of borehole and/or formation properties, and/or communication between downhole and surface systems. Many such downhole tools are powered by electrical energy. The electrical energy that powers downhole tools may be generated at the surface and conducted downhole. Alternatively, the electrical energy powering a downhole tool may be generated downhole.

### SUMMARY

A system and method for generation of electrical energy in a wellbore are disclosed herein. In one embodiment, a downhole tool for use in a wellbore includes a housing and a power generation system disposed within the housing. The power generation system includes a power section and an axial flux generator. The power section is configured to convert flow of drilling fluid through the downhole tool to rotation. The axial flux generator is coupled to the power section. The axial flux generator is configured to produce magnetic flux that extends parallel to an axis of the rotation, and to generate electrical energy responsive to the rotation.

In another embodiment, a method for generating power in a downhole tool used in a wellbore includes pumping drilling fluid into a drill string disposed in the wellbore. Movement of the drilling fluid through a power section disposed in the drill string is converted into rotation of a shaft in the power section. A rotor of an axial flux generator coupled to the shaft is rotated by the rotation of the shaft. Electrical energy is generated in the axial flux generator, via the magnetic flux, responsive to the rotating of the rotor.

In a further embodiment, a system for generating electrical energy downhole includes an axial flux permanent magnet machine and a power section. The axial flux permanent magnet machine includes a plurality of disks arranged in a stack wherein a face of one of the disks is adjacent to a face of another of the disks. At least one of the disks is a stator that includes a plurality of wire coils, and at least one of the disks is a rotor that includes a plurality of permanent magnets arranged in correspondence with the wire coils of an adjacent stator. The power section is configured to rotate the rotor of the axial flux permanent magnet machine responsive to flow of drilling fluid through the power section. Rotation of the rotor by the power section generates

### BRIEF DESCRIPTION OF THE DRAWINGS

For a detailed description of exemplary embodiments of the invention, reference will now be made to the figures of the accompanying drawings. The figures are not necessarily to scale, and certain features and certain views of the figures may be shown exaggerated in scale or in schematic form, and some details of conventional elements may not be shown in the interest of clarity and conciseness.

FIG. 1 shows a drilling system that includes downhole power generation in accordance with principles disclosed herein;

FIG. 2 shows a schematic diagram of a downhole power generation system in accordance with principles disclosed herein;

FIG. 3 shows views of an exemplary axial flux permanent magnet machine in accordance with principles disclosed herein;

FIG. 4 shows a schematic diagram of a downhole power generation system arranged to allow fluid flow through a generator in accordance with principles disclosed herein;

FIG. 5 shows a schematic diagram of a downhole power generation system that integrates a generator and a power system bearing assembly in accordance with principles disclosed herein; and

FIG. 6 shows a schematic diagram of a downhole tool using an axial flux permanent magnet machine as both a generator and a motor in accordance with principles disclosed herein.

### NOTATION AND NOMENCLATURE

Certain terms are used throughout the following description and claims to refer to particular system components. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through direct engagement of the devices or through an indirect connection via other devices and connections. The recitation “based on” is intended to mean “based at least in part on.” Therefore, if X is based on Y, X may be based on Y and any number of other factors.

### DETAILED DESCRIPTION

In the drawings and description that follow, like parts are typically marked throughout the specification and drawings with the same reference numerals. The present disclosure is susceptible to embodiments of different forms. Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings and components of the embodiments discussed below may be employed separately or in any suitable combination to produce desired results.

Conventional downhole power generation generally employs an alternator driven by a turbine through a gearbox. Impellers of the turbine convert the flow of drilling fluid into rotation. The gearbox turns the alternator and adapts the rotation rate of the turbine for use by the alternator. For example, the gearbox may provide an increased rate of rotation to the alternator with respect to the turbine where the turbine rotation rate is too low to generate adequate power via the alternator. The alternator is conventionally a radial flux machine in which magnetic flux extends radially with respect to the alternator's axis of rotation. The radial flux machine is generally cylindrical in shape, and a radial flux alternator of a downhole power generation system may occupy a substantial portion of the length of a downhole tool.

Embodiments of the downhole power generation system disclosed herein provide a reduction in both area and complexity relative to conventional systems. Rather than the radial flux machines used in conventional systems, embodiments of the present disclosure generate power downhole using an axial flux machine. In an axial flux machine, magnetic flux extends axially with respect to the machine's axis of rotation (i.e., parallel to the machine's axis of rotation). The axial flux machine is disk shaped, and can produce sufficient electrical energy to power a downhole tool at a substantially lower rotation rate than is required using a radial flux generation system. Consequently, the axial flux machine can be directly driven by a turbine rather than driven via a gearbox. As a result, embodiments of the downhole power generation system disclosed herein occupy a substantially smaller lengthwise portion of a downhole tool than a conventional downhole power generation system.

In some embodiments of the downhole power generation system disclosed herein, the axial flux machine generates direct current (DC) electrical energy. In such embodiments, the complexity of the power generation system is further reduced by eliminating the need for complex rectification circuitry.

In some downhole tools, the axial flux machine may be used as a motor as well as a generator. In such tools, the axial flux machine may be used to drive various mechanisms the affect tool operation.

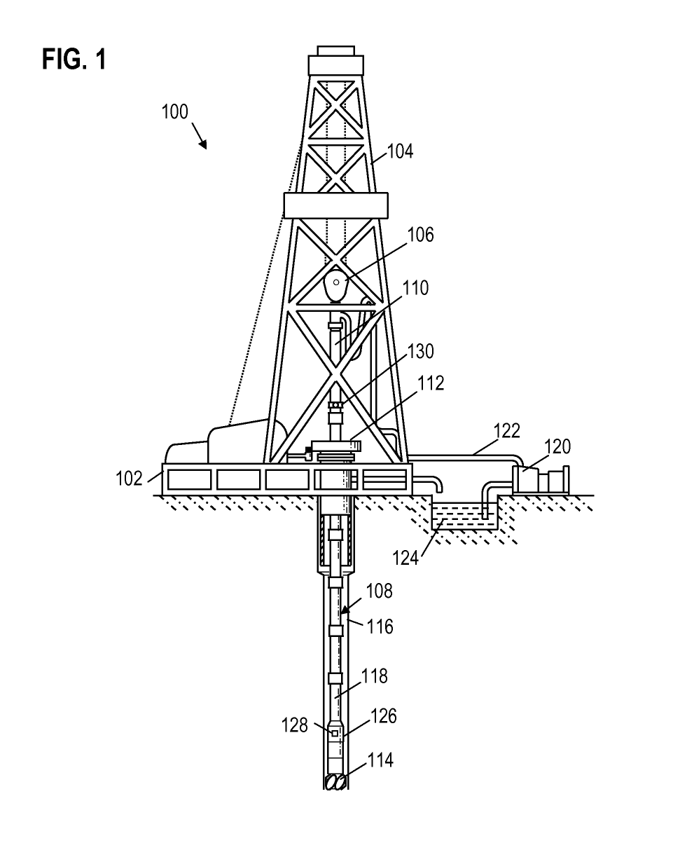

FIG. 1 shows a drilling system 100 that includes downhole power generation in accordance with principles disclosed herein. In the drilling system 100, a drilling platform 102 supports a derrick 104 having a traveling block 106 for raising and lowering a drill string 108. A kelly 110 supports the drill string 108 as it is lowered through a rotary table 112. In some embodiments, a top drive is used to rotate the drill string 108 in place of the kelly 110 and the rotary table 112. A drill bit 114 is driven by a downhole motor and/or rotation of the drill string 108. As drill bit 114 rotates, it creates a borehole 116 that passes through various subsurface formations. A pump 120 circulates drilling fluid through a feed pipe 122 to kelly 110, downhole through the interior of drill string 108, through orifices in drill bit 114, back to the surface via the annulus around drill string 108, and into a retention pit 124. The drilling fluid transports cuttings from the borehole into the pit 124 and aids in maintaining the borehole integrity.

The drill string 108 is made up of various components, including drill pipe 118, drill bit 114, and other downhole tools. The drill pipe 118 may be standard drill pipe or wired drill pipe. The drill string 108 includes a downhole tool 126 that is operated via electrical energy. The electrical energy powering the downhole tool 126 is generated downhole by the power generation system 128. The power generation system 128 may be disposed within the downhole tool 126 or elsewhere in the drill string 108.

The power generation system 128 includes a direct drive permanent magnet machine that generates electrical energy from rotation induced by the flow of drilling fluid through the drill string 108. The direct drive permanent magnet machine includes an axial flux machine that can generate power at the relatively low rotation rate induced by the flow of drilling fluid.

While the system 100 is illustrated with reference to an onshore well and drilling system, embodiments of the system 100 are also applicable to power generation and control in offshore wells. In such embodiments, the drill string 108 may extend from a surface platform through a riser assembly, a subsea blowout preventer, and a subsea wellhead into the subsea formations.

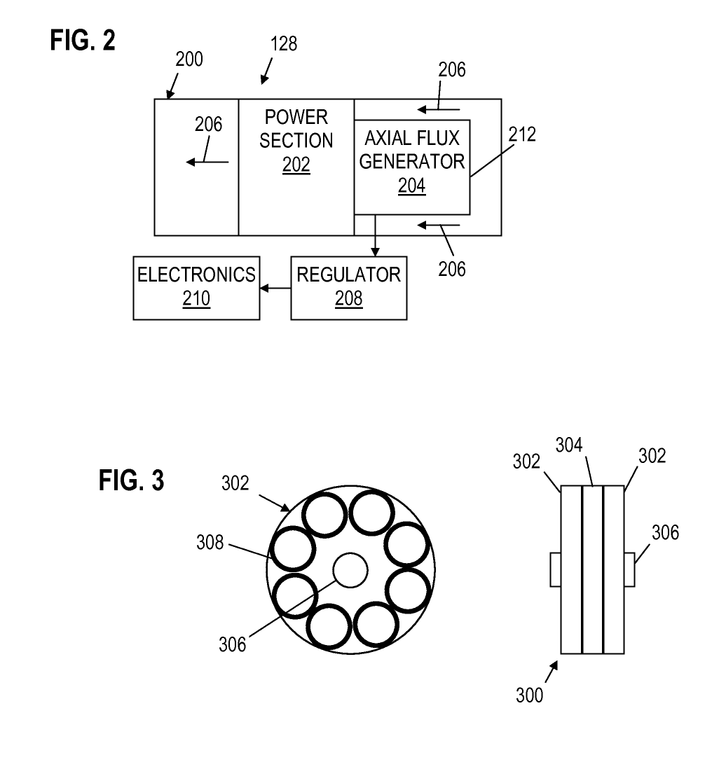

FIG. 2 shows a schematic diagram of the downhole power generation system 128 in accordance with principles disclosed herein. The downhole power generation system 128 includes a power section 202 and an axial flux generator 204 disposed in a bore formed by the interior surface of housing 200. Housing 200 may be generally cylindrical in shape. The power section 202 may include a turbine, a progressive cavity pump, or other device that converts the flow of drilling fluid 206, pumped through the drill string 108 from the surface, into rotation.

The power section 202 is coupled to the axial flux generator 204, and provides rotation to the axial flux generator 204. The axial flux generator 204 may include an axial flux permanent magnet machine disposed in a housing 212. The housing 212 may be dimensioned to allow flow of drilling fluid 206 around the axial flux generator 204 to the power section 202. In other embodiments, the axial flux generator 204 may be disposed downstream of the power section 202. The axial flux generator 204 converts the rotary energy provided by the power section 202 into electrical energy. Because the axial flux generator is directly coupled to the power section 202, rather than coupled through a gearbox as in conventional systems, the rotation rate of the axial flux generator 204 may be relatively low. In various embodiments, the electrical energy produced by the axial flux generator 204 may include direct current or alternating current.

The electrical energy generated by the axial flux generator 204 is conducted to a regulator 208. The regulator 208 can adjust the voltage and/or current of the electrical energy produced by the axial flux generator 204 to ensure that the voltage and/or current provided to devices powered by the electrical energy is within a predetermined operational range. For example, the regulator 208 may include a buck/boost switching power converter that produces a predetermined output voltage from the electrical energy provided by the axial flux generator 204. Voltage and/or current output by the regulator 208 is provided to electronics 210 or other electrical devices in the downhole tool 126 or elsewhere in the drill string 108.

FIG. 3 shows views of an illustrative axial flux permanent magnet machine 300 in accordance with principles disclosed herein. The axial flux permanent magnet machine 300 is suitable for use in the axial flux generator 204. The axial flux permanent magnet machine 300 includes a plurality of disks 302, 304, and shaft 306. Disks 302 may be stators and disk 304 may be a rotor. Disk 302 includes a plurality of coils 308, and disk 304 includes a plurality of permanent magnets arranged in correspondence to the coils 308. The magnets may be arranged with alternating north-south orientation. The magnets of the disk 304 and the coils 308 of the disks 302 face one another when the disks are stacked as shown in FIG. 3. The coils 308 may be wound parallel to the disk 302.

The shaft 306 is coupled to a shaft of the power section 202, and rotation generated in the power section causes the disk 304 to rotate via the shaft 306, while the disks 302 remain stationary relative to the disk 304. Rotation of the disk 304 produces changes in magnetic flux as the magnets of the disk 304 move past the coils 308. The changes in magnetic flux induce current flow in the coils 308. Conductors connected to the coils transfer the generated electrical energy to the regulator 208. The relatively large number of magnets and coils operating in concert allow the axial flux permanent magnet machine 300 to generate substantially more electrical energy at a low rotation rate than would be provided by a conventional downhole energy generation system at the same rate of rotation. Thus, the axial flux generator 204 can be directly connected to the power section 202, rather than connected through a gearbox that increases the rate of rotation provided to the generator 204.

Because the axial flux permanent magnet machine 300 is disk-shaped, the lengthwise area occupied by the axial flux generator 204 may substantially smaller than for an equivalent radial flux generator. Accordingly, the size of the downhole power generation system 128 is reduced relative to conventional power generation systems. The reduction in size may allow for inclusion of additional sensors/subsystems in the downhole tool 126, and/or allow for reduction in length of the tool 126.

Embodiments of the axial flux permanent magnet machine 300 may include any number of rotors 304 and corresponding stators 302, where increasing the number of rotors and stators stacked may produce a correspondent increase in electrical current generated. A variety of differently configured axial flux permanent magnet machines may be applied in the axial flux generator 204. For example, an axial flux permanent magnet machine that generates direct current rather than alternating current may be included in the axial flux generator 204 to alleviate the need for rectifiers. Some embodiments of an axial flux permanent magnet machine included in the axial flux generator 204 may include a stator disposed between rotors.

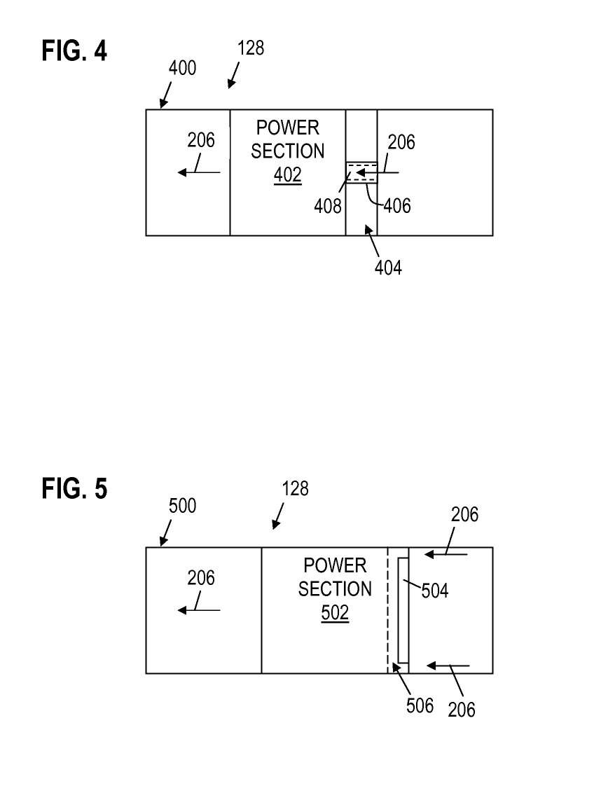

FIG. 4 shows a schematic diagram of a downhole power generation system 128 arranged to allow fluid flow through the axial flux generator in accordance with principles disclosed herein. The power generation system 128 of FIG. 4 includes a power section 402 and an axial flux generator 404 disposed in a bore formed by the interior surface of housing 400. Housing 400 and the power section 402 may be as described with reference to the housing 200 and the power section 402 disclosed with respect to FIG. 2.

The power section 402 is coupled to the axial flux generator 404, and provides rotation to the axial flux generator 404. The axial flux generator 404 includes an axial flux permanent magnet machine. A shaft or other rotatable structure of the power section 402 is coupled to a shaft 406 of the permanent magnet machine, and induces rotation of the shaft 406. The shaft 406 includes a bore 408. Drilling fluid 206, pumped through the drill string 108 from the surface, passes through the bore 408 into the power section 402, and causes the power section to induce rotation in the axial flux generator 404. Thus, in the downhole power generation system 128 of FIG. 4, drilling fluid flows through the axial flux generator 404 in addition to or in lieu of flowing around the axial flux generator 404.

FIG. 5 shows a schematic diagram of a downhole power generation system 128 that integrates the generator and the power system bearing assembly in accordance with principles disclosed herein. The power generation system 128 of FIG. 5 includes a power section 502 and an axial flux generator 504 disposed in a bore formed by the interior surface of housing 500. Housing 500 and the power section 502 may be substantially as described with reference to the housing 200 and the power section 402 disclosed with respect to FIG. 2.

As explained above, an axial flux permanent magnet machine may be formed as a relatively thin disk. The power generation system 128 of FIG. 5 takes advantage of the disk shape of the axial flux generator 504 by incorporating the axial flux generator 504 in a bearing assembly 506 of the power section 502. The bearing assembly 506 may include roller bearings that facilitate rotation of a shaft of the power section 502 induced by the flow of drilling fluid 206. The rotor(s) of the axial flux generator 504 may be directly or indirectly coupled to the shaft of the power section 502 in the bearing assembly. By incorporating the axial flux generator 504 in the bearing assembly 506 of the power section 502, the length of the power generation system 128 is further reduced, allowing for a reduction in the length of downhole tools in which the power generation system 128 is to be applied.

In addition to generating electrical energy, an axial flux permanent magnet machine may operate as motor. As described with reference to the axial flux permanent magnet machine 300, generation of electrical energy is induced by rotation of the shaft 306, which in turn, rotates the rotor 304. The axial flux permanent magnet machine 300 may function as a motor by driving current through the coils 308. The current induces magnetic fields that cause the rotor 304 to rotate, and in turn rotate the shaft 306. Accordingly, in some embodiments of the downhole tool 126, an axial flux permanent magnet machine may be applied as a motor to provide mechanical actuation and/or as a generator to generate electrical energy. For example, an axial flux permanent magnet machine may operate as a generator during intervals when mechanical actuation is not needed, and at other times operate as a motor to open valves when needed, activate a tool, etc.

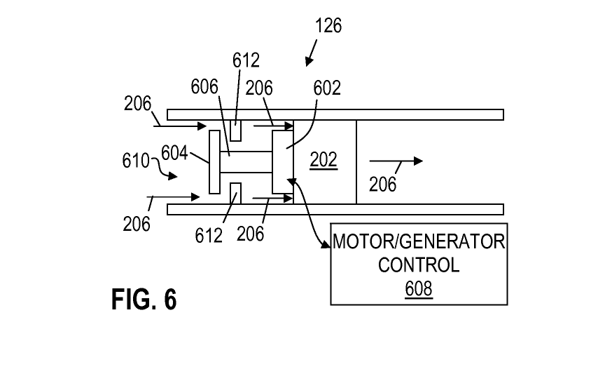

FIG. 6 shows a schematic diagram of the downhole tool 126 applying an axial flux permanent magnet machine as both a generator and a motor in accordance with principles disclosed herein. The downhole tool 126 of FIG. 6 includes a valve 604 disposed in a bore 610. The valve 604 may be opened to allow fluid (e.g., drilling fluid 206) to flow through the bore 610. Fluid flow is inhibited when valve 604 is positioned against valve seats 612.

The downhole tool 126 also includes an axial flux permanent magnet machine 602, a power section 202, and motor/generator control circuitry 608. The motor/generator control circuitry 608 controls the operation of the axial flux permanent magnet machine 602 by configuring the axial flux permanent magnet machine 602 to operate as either a motor or a generator. Accordingly, the motor/generator control circuitry 608 may include switches to route electrical energy produced by the axial flux permanent magnet machine 602 to an energy storage system (e.g., a battery), and drive circuitry to drive current to the axial flux permanent magnet machine 602 for operation as a motor.

The axial flux permanent magnet machine 602 is coupled to the valve 604 via a shaft 606. The axial flux permanent magnet machine 602 may operate as a motor to rotate the shaft. Rotation of the shaft 606 in one direction may cause the valve 604 to open, and rotation of the shaft 606 in the opposite direction may cause the valve 604 to close. For example, at least a portion of the shaft 606 may be threaded such that rotation of the shaft causes the valve 604 to move.

When the valve 604 is open, fluid flowing through the power section 202 may induce rotation in the power section 202, and the motor/generator control circuitry 608 may configure the axial flux permanent magnet machine 602 to operate as a generator. Accordingly, the power section 202 may induce rotation in the axial flux permanent magnet machine 602 thereby causing the axial flux permanent magnet machine 602 to generate electrical energy that can be stored for use by other devices or subsequent motor application of the axial flux permanent magnet machine 602.

The above discussion is meant to be illustrative of various embodiments of the present invention. Numerous variations and modifications will become apparent to those skilled in the art once the above disclosure is fully appreciated. It is intended that the following claims be interpreted to embrace all such variations and modifications.

1. A downhole tool for use in a wellbore, comprising:
a housing; and
a power generation system disposed within the housing, the power generation system comprising:
a power section configured to convert flow of drilling fluid through the downhole tool to rotation; and
an axial flux generator coupled to the power section, the axial flux generator configured to:
produce magnetic flux that extends parallel to an axis of the rotation; and
generate electrical energy responsive to the rotation.

2. The downhole tool of claim 1, wherein the axial flux generator is directly coupled to the power section, and the power generation system is configured to rotate the axial flux generator and the power section at a same rate.

3. The downhole tool of claim 1, wherein the axial flux generator comprises:
an axial flux permanent magnet machine, comprising:
a plurality of disks arranged in a stack wherein a face of one of the disks is adjacent to a face of another of the disks;
wherein at least one of the disks is a stator comprising a plurality of wire coils, and at least one of the disks is a rotor comprising a plurality of permanent magnets arranged in correspondence with wire coils of an adjacent stator;
wherein rotation of the rotor by the power section generates electrical energy in the coils.

4. The downhole tool of claim 3, wherein the axial flux permanent magnet machine is configured to operate as a motor by driving current through the coils.

5. The downhole tool of claim 4, further comprising:
an actuator coupled to the rotor;
motor/generator control circuitry coupled to the axial flux permanent magnet machine, the motor/generator control circuitry configured to drive current into the coils to enable operation of the actuator.

6. The downhole tool of claim 1, wherein the axial flux generator is configured to directly generate direct current responsive to the rotation.

7. The downhole tool of claim 1, wherein the axial flux generator comprises a central shaft about which the axial flux generator rotates, and the shaft comprises a bore through which drilling fluid flows to the power section.

8. The downhole tool of claim 1, wherein the power generation system comprises a bearing assembly configured to reduce rotational friction of a shaft rotated by the power section;
where the axial flux generator is housed in the bearing assembly.

9. A method for generating power in a downhole tool used in a wellbore, comprising:
pumping drilling fluid into a drill string disposed in the wellbore;
converting movement of the drilling fluid through a power section disposed in the drill string into rotation of a shaft in the power section;
rotating a rotor of an axial flux generator coupled to the shaft;
generating magnetic flux parallel to an axis of rotation of the rotor;
generating, via the magnetic flux, electrical energy in the axial flux generator responsive to the rotating.

10. The method of claim 9, further comprising directly connecting the rotor to the shaft and rotating the rotor at a same rate as the shaft.

11. The method of claim 9, further comprising generating the electrical energy in a plurality of coils of a stator disposed parallel to rotor.

12. The method of claim 11, further comprising operating the axial flux generator as motor by driving current through the coils.

13. The method of claim 12, further comprising operating an actuator of the downhole tool by the operating the axial flux generator as a motor.

14. The method of claim 9, wherein the axial flux generator is disposed in a bearing assembly coupled to the shaft.

15. A system for generating electrical energy downhole, comprising:
an axial flux permanent magnet machine comprising:
a plurality of disks arranged in a stack wherein a face of one of the disks is adjacent to a face of another of the disks;
wherein at least one of the disks is a stator comprising a plurality of wire coils, and at least one of the disks is a rotor comprising a plurality of permanent magnets arranged in correspondence with the wire coils of an adjacent stator;
a power section configured to rotate the rotor of the axial flux permanent magnet machine responsive to flow of drilling fluid through the power section;
wherein rotation of the rotor by the power section generates the electrical energy in the coils.

16. The system of claim 15, wherein the power section is not coupled to the rotor via a transmission.

17. The system of claim 15, further comprising motor/generator control circuitry coupled to the axial flux permanent magnet machine, the motor/generator control circuitry configured to operate the axial flux permanent magnet machine as a generator and a motor; wherein the motor/generator control circuitry operates the axial flux permanent magnet machine as a motor by driving current into the coils.

18. The system of claim 15, wherein the axial flux permanent magnet machine is configured to directly generate direct current responsive to the rotation.

19. The system of claim 15, wherein the axial flux permanent magnet machine comprises a central shaft about which the rotor rotates, and the shaft comprises a bore through which drilling fluid flows to the power section.

20. The system of claim 15, further comprising a bearing assembly configured to reduce rotational friction of a shaft rotated by the power section; where the axial flux permanent magnet machine is housed in the bearing assembly.

21. The method of claim 9, further comprising generating direct current in the axial flux generator directly via the rotation.

22. The method of claim 9, further comprising providing the drilling fluid to the power section through a bore of the shaft.
